(19) United States
(12) Patent Application Publication
(10) Pub. No.: US 2004/0111283 A1
(43) Pub. Date: Jun. 10, 2004

(54) Customer cleaned rentable asset

(76) Inventor: Stelios Haji-Ioannou, London (GB)

Correspondence Address: OSTROLENK FABER GERB & SOFFEN, 1180 AVENUE OF THE AMERICAS, NEW YORK, NY, 100368403

(21) Appl. No.: 10/316,227

(22) Filed: Dec. 10, 2002

(51) Int. Cl. G06F 17/60

(52) U.S. Cl. 705/1

(57) ABSTRACT

A method of renting a rentable asset, in particular a car, under a rental agreement with a lessee who will be charged a rental fee for the rental period the asset is rented and a penalty fee if the asset or car is returned dirty. The car is not serviced or refueled after return of the car by the prior lessee and before rerenting the car, minimizing labor during that stage and enabling rapid rerenting of the car.

### BACKGROUND OF THE INVENTION

The invention concerns a method of encouraging customers or lessees for a reusable asset, of which a car is an example, to return the asset to the renter or lessor in a clean state, generally the state of cleanliness that the asset had at the time it was rented to the customer. The basic concept is that if the customer does not return the asset in a sufficiently clean state, determined by inspection of the asset, the customer pays a penalty in addition to the agreed upon rental fee.

Various assets are rented or leased to a customer for a time period less than the entire useful life of the asset, are inspected for their condition upon return of the leased asset, are possibly repaired or cleaned by the renter or lessor and then rented to a subsequent customer or lessee. Many rental or lease agreements contain a provision that if the asset is returned in a damaged or excessively deteriorated or dirty condition, the customer or lessee is responsible for the cost of returning the asset to at least a rentable condition. The lessor or renter repairs and cleans, as required, not the customer or lessee.

In present car rental businesses, a customer or lessee receives a car that is acceptably clean to the customer. For example the renter or lessor has cleaned the interior, removed refuse and dirt and has cleaned and washed the exterior. At the end of the rental or lease term when the customer returns the vehicle, he cannot return it in a physically damaged condition. But, he is not required to have cleaned the vehicle either inside or outside. The car rental facility has personnel who inspect the vehicle for damage and cleanliness, who clean the interior of the vehicle, remove refuse and clean off dirt and who clean and wash the exterior of the vehicle. Cleaning and washing take considerable personnel time and require facilities and equipment for the cleaning, as well as storage space for the vehicles waiting to be cleaned and possibly for storage after the vehicles are cleaned.

A method or system for cleaning certain rentable assets, with the customer knowing in advance of his responsibility for cleaning his asset before returning it and being penalized if the asset has not been cleaned before the return, is not a known method.

### SUMMARY OF THE INVENTION

The invention has several objectives, all of which may not be achieved, but which the invention is intended to accomplish.

The primary objective is to speed the time from return of the asset by one customer or lessee to availability of the asset for rerental and delivery to a subsequent customer or lessee. To keep the asset earning income as much as possible, it should be rerented as soon as possible.

Another object is to encourage a customer or lessee to return the rerentable asset in a clean, ready to rerent condition.

Yet another object is to reduce the number of personnel required at a rental facility for cleaning of the asset and for storage of the asset before cleaning and possibly also after cleaning.

Another object is to minimize the volume of storage space required for the assets by rerenting them more rapidly and therefore fewer of the assets need be stored between rentals.

The invention was initially developed for rental of automotive vehicles or cars. The subsequent description herein will be with respect to cars, although the invention is not restricted to that application. The invention may be used with any reusuable asset, and primarily an asset which the customer or lessee may remove from a facility at which the asset has been rented and which the customer subsequently returns. However, the concept of the invention may be adapted to stationary assets, where the customer or lessee temporarily uses or works on or with the asset in situ and then leaves the asset so that it can be temporarily rented to another party.

According to the invention, when a customer or lessee rents a car, the rental agreement requires the customer to return the car in a clean condition, both at the inside and outside of the car. The agreement states that there will be an additional charge to the customer if the car is returned dirty either inside or outside. The amount of the charge need not be high, but is set in the agreement at a level that would at least compensate the rental facility for having to inspect and clean the car and would also be more than the cost of commercially washing and cleaning the car, but not so high as to cause concern to a customer when he is renting the car and not so high as to severely penalize the customer who, for reasons of time, or habit, or laziness, chooses not to clean the car and chooses to pay the penalty.

The car is inspected for cleanliness by personnel of the rental facility when the rented car is returned. The standard of cleanliness for inspection personnel will be based on the experience of the rental facility and the inspectors as to what will be acceptable to the next customer who rents. It is undesirable for the next customer to refuse to rent a particular car because it is dirty.

The inventor hereof has observed that at a typical car rental facility, about one half of personnel labor time is devoted to washing and cleaning cars. If that labor time expenditure can be largely eliminated, the personnel required for performing that function can be correspondingly reduced, and rented cars can be made available for the next lessee or customer more rapidly.

By practicing the invention with respect to car rentals, it might not be atypical to have a car returned at a particular time, to have it inspected for condition and cleanliness, and for the next customer to rent the returned car and leave the car rental facility under ten minutes after the car was returned. The method of the invention eliminates a time period while a car is waiting to be cleaned at the rental facility. With more rapid recycling from car return to rerenting, without need for the extensive amount of work and time devoted to cleaning the car, fewer personnel are needed for cleaning and washing the cars, and fewer spaces for parking or storage of the car are needed as there are fewer cars that are awaiting a cleaning step.

Because of the possibly more rapid recycling from car return to rerenting, the method of the invention improves asset utilization, which is the purpose of the invention. This method allows very short term rentals, since quick turnaround on a particular car is possible.

It has been the inventor's experience and expectation that about 85% of the cars rented according to this invention will be returned ready for rerenting, and that only 15% of the cars will require cleaning and washing after inspection.

If the method of the invention is adopted by a single rental car company or becomes even more widely adopted, one of the goals of invention, to train customers to behave in a particular way, should be achieved, and this will promote higher utilization of cars for each rental facility.

In a further development of the invention, each car returned is rented to a subsequent renter in the condition in which it is returned, i.e. clean. The car is not otherwise serviced by the rental facility and fuel is not added to the fuel tank before rerenting. The renting customer has no obligation to service the car, or fill the fuel tank or bring the fuel tank to any level, regardless of the amount of fuel that was in the tank when the car was rented to him. This also saves the rental facility time and labor in servicing the car and filling the fuel tank.

The present invention is useful for any rentable asset. Cars are the primary example. It is useful for other vehicles and trucks, useful for machines and tools and for portable assets and/or for temporary use assets which are used at the renter's or lessor's premise.

The invention could be adapted to stationary assets which the lessee or customer temporarily occupies and uses and then leaves. An example is a hotel room. The lessee or customer would be required in the rental agreement to leave the premises in a clean condition, i.e. the condition of the premises when the lessee arrived.

Other objects and features of the invention will become apparent from the following description of a preferred embodiment illustrated by the accompanying drawing.

### BRIEF DESCRIPTION OF THE DRAWING

FIG. 1 depicts a flow chart of action utilizing the method of the invention particularly directed to a rentable asset, a car.

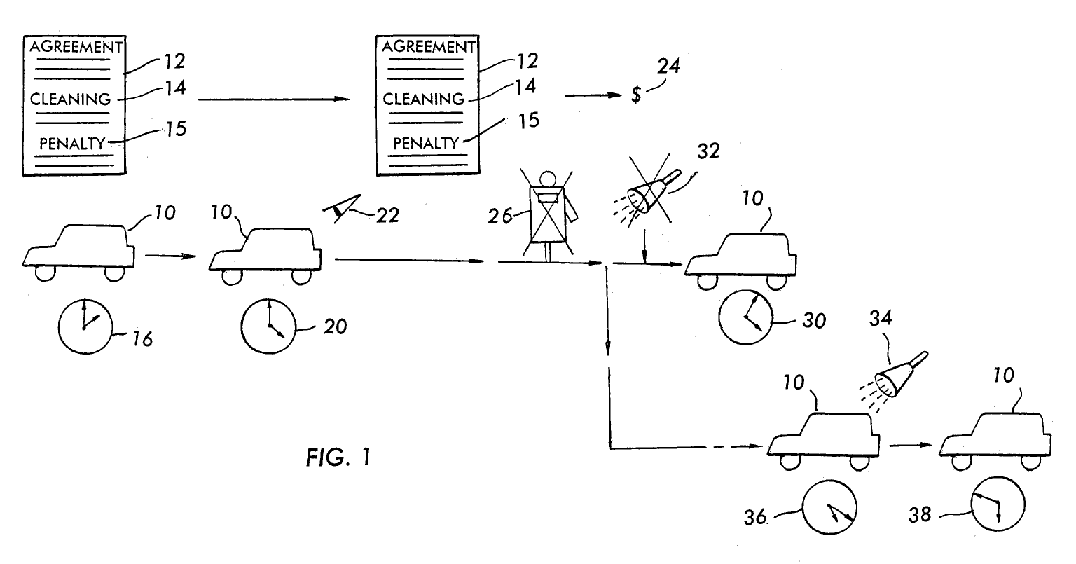

### DESCRIPTION OF A PREFERRED EMBODIMENT OF THE INVENTION

The invention is described in conjunction with the accompanying flow chart which deals with the rental of a car. The invention is adaptable for use for any rentable asset which is capable of becoming dirty while in the lessee's or customer's possession or custody and which can be made clean by the customer before returning the asset to the rental facility.

A car rental facility rents a car 10 to a customer at the time 16. The accompanying rental agreement 12 includes a provision 14 for cleaning the car, which states that the lessee or customer must return the car clean, e.g. as clean as it was when rented. The agreement has a penalty provision 15, payable if the car is returned dirty. Both the price of the rental and the dirty car penalty are set before the agreement is entered.

The lessee or customer returns the car 10 to the same rental facility or to another facility in the chain of rental agencies at the time 20. The vehicle is inspected 22 at the rental facility. If the car 10 is dirty, the penalty clause 15 of the agreement 12 is invoked, and the renter is required to pay the penalty fee 24. If the car is returned clean, the penalty clause is not invoked. At time 30, which may be merely a few minutes past time 20, the car that was returned clean is available for rerenting. The car is not serviced or refueled at 26 and need not be washed 32.

If the car 10 is returned excessively dirty, the car may be brought for cleaning 34 at time 36 and then sent for rerental, but this time 38 at many more minutes after the vehicle is returned. In any event, there is no refueling 26, and no other servicing of the vehicle is done, which shortens the time interval between time 20 and either time 30 or time 38.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of renting a cleanable asset, comprising:
pricing the rental to a lessee of the asset at a rental price for a rental period;
pricing a penalty fee to be charged to the lessee of the asset at the end of the rental period if the asset is not returned to an entity who wishes to rerent the asset in a clean condition;
renting the rentable asset to a lessee for the rental period when the lessee agrees to the rental price for rental for the rental period and agrees to pay the penalty fee if the asset is returned dirty;
delivering the asset to the lessee in a condition clean enough that the lessee will accept the asset for rental;
the lessee returning the asset to the entity, who wishes to rerent the asset, and at a location acceptable under the rental agreement,
after the lessee returns the asset to the entity, inspecting the asset to determine if it has a degree of cleanliness adequate to be rentable to a subsequent lessee, and if the asset is not clean to that degree, charging the lessee the penalty fee for not returning an adequately cleaned asset, and then cleaning the asset to a degree sufficient that it can be rentable; and
after the cleaning or if the inspection shows the asset to be clean to a rentable degree, the entity rerenting the asset to another lessee for another rental period.

2. The method of claim 1, wherein in the period between return of the asset by a prior lessee and delivery of the asset to a subsequent lessee, not servicing the asset, except for the inspecting of the asset to determine if it has the degree of cleanliness and cleaning the asset if it does not have the degree of cleanliness.

3. The method of claim 1, wherein the asset is a car and the degree of cleanliness comprises an acceptable degree of cleanliness of the inside of the car and an acceptable degree of cleanliness of the outside of the car.

4. The method of claim 3, wherein the penalty fee to a lessee is more than a standard charge for cleaning the car in a general area where the entity to which the car is returned is located.

5. The method of claim 3, wherein between the return to the car by a prior lessee and delivery of the car to a subsequent lessee, no fuel is supplied to the vehicle by the entity rerenting the car.
